(19) United States
(12) Patent Application Publication
(10) Pub. No.: US 2011/0175722 A1
(43) Pub. Date: Jul. 21, 2011

(54) WIRELESS DEVICE INVENTORY SCANNER

(76) Inventors: Peter Jensen, Euclid, OH (US); Richard F. Kaplan, Euclid, OH (US)

(21) Appl. No.: 12/689,365

(22) Filed: Jan. 19, 2010

(51) Int. Cl. G08B 1/08

(52) U.S. Cl. 340/539.1

(57) ABSTRACT

The invention relates to an apparatus that Alerts a user that one or more Wireless-Capable Devices are not present at the time of a Triggering Event. The presence or non-presence of the Wireless-Capable Devices is determined by Wireless Detection of the Wireless-Capable Devices by the present invention.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

The present invention relates to an apparatus for scanning to determine if a set of wireless devices are located within detection range and, if not present, to signal this absence with visual and/or audible alarms.

In the modern world, people have become increasingly reliant on their wireless devices: cell phones, music players, personal digital assistants, and other such devices. However powerful these devices may be, they can be rendered useless by a simple act of forgetfulness on the part of the owner. If, for example, the owner of a cell phone were to inadvertently leave a restaurant without their cell phone, the owner could potentially drive away from the restaurant without any indication that his/her phone was left behind. Lack of timely notification of the cell phone's absence, when the owner departs the restaurant, would be an inconvenience at best, or, at worst, results in the loss of the cell phone, all the stored information, and charges for multiple overseas phone calls.

If, however, the cell phone owner had been in possession of the present invention, then, when he/she started his/her car, the present invention would have provided a visual and/or audio alarm, at the time the car was started, indicating that the cell phone was not present, thereby giving the opportunity to retrieve the missing device before ever leaving the restaurant's parking lot.

While there exist other inventions for determining that a cell phone has lost its wireless link with other devices, no prior invention conducts a wireless scan for a set of devices at the time of a triggering event, such as the starting of a car, and provides prompt feedback as to whether any or all of the devices are missing.

### SUMMARY OF THE INVENTION

The invention relates to an apparatus that Alerts a user that one or more Wireless-Capable Devices are not present at the time of a Triggering Event. The presence or non-presence of the Wireless-Capable Devices are determined by Wireless Detection of the Wireless-Capable Devices.

### BRIEF DESCRIPTION OF THE DRAWINGS

Other features and advantages of the present invention will become apparent in the following detailed descriptions of the preferred embodiment with reference to the accompanying drawings, of which:

FIG. 1 is a flow diagram from the Triggering Event to Scan Mode or Discover Mode in accordance with the present invention;

FIG. 2 is a flow diagram of Scan Mode in accordance with the present invention;

FIG. 3 is a flow diagram of Discover Mode in accordance with the present invention;

FIG. 4 is a flow diagram of Alert Mode in accordance with the present invention.

FIG. 5 is a flow diagram of Idle Mode in accordance with the present invention;

FIG. 6 is a diagrammatic representation of the external structure of one possible embodiment in accordance with the present invention; and

FIG. 7 is a diagrammatic representation of the internal structure of one possible embodiment in accordance with the present invention.

### DETAILED DESCRIPTION OF THE INVENTION

In the description of the invention above and in the detailed description of the invention, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The invention described herein is, a Wireless Device Inventory Scanner (“Scanner”).

The Scanner is an apparatus that Alerts a user that one or more Wireless-Capable Devices are not present at the time of a Triggering Event. The presence or non-presence of the Wireless-Capable Devices is determined via Wireless Detection of the Wireless-Capable Devices by the Scanner.

A Wireless-Capable Device (“WCD”) is an apparatus that can communicate using radio frequency emissions and/or reception. Examples of a Wireless-Capable Device are cell phones, personal digital assistants, wireless headsets, transmitters, transponders, and radio frequency identification (“RFID”) tags, amongst others.

Wireless Detection is the procedure used to determine the presence of a Wireless-Capable Device. When Wireless Detection is performed, a pre-agreed wireless protocol is used by the Scanner to communicate with the Wireless-Capable Device. If the WCD does not respond appropriately using the pre-agreed wireless protocol, then the WCD is determined to be not present. If the wireless protocol specifically supports sending identifying information about devices, an appropriate response is one that sufficiently identifies the device. If the protocol does not support a mode that sends identifying information about the WCD, then any response received which could come from the WCD may be sufficient to qualify as an appropriate response.

There are many wireless protocols commonly available and well known in the art which may be used for Wireless Detection. Some examples include Bluetooth, Zigbee, Wireless USB, and Wi-Fi, among others, also including protocols that do not have industry standards associated with them. Some protocols would require the Scanner to emit a radio frequency signal, and, if present, the Wireless-Capable Device will respond. Some of these protocols further require a specific sequence of handshaking and exchange of information/codes by and between the Scanner and WCD before the WCD will uniquely identify itself. Other protocols may transmit without receiving a signal from the Scanner, and the Scanner need only wait to receive the radio frequency signal from the WCD.

In response to a Triggering Event, the Scanner will perform Wireless Detection of the WCD, and then provide an Alert if the WCD is determined to be not present. The Triggering Event is either the application of power to the Scanner, or a signal from a sensor, processor or switch coupled to/with the Scanner. Sensors are commonly available and well known in the art, and can be used to detect the opening door of a car, the presence of an individual in the driver's seat, a digital signal, an analog signal, the starting a car, a pre-determined sound, the turning of a door knob, or a voice command, amongst others.

The Alert gives a warning and/or draws the attention of the user to the Scanner. Alerts are well known in the art and some examples are an audible sound, a visual indication, tactile stimulus, or a combination thereof. The Alert can comprise, for example, an audible tone from an audio transducer, light from light emitting diodes (LEDs) of various colors, vibration, email, instant message, text page, message display on a car console, or a message display on a liquid crystal display coupled to the Scanner, amongst others.

In a preferred embodiment, the WCD is a cell phone with Bluetooth wireless protocol capability, and the Triggering Event is the application of power to the Scanner by a car's electrical system at the time of the starting of the vehicle in which the Scanner is located, and the Alert is an audible tone and flashing red LED.

In a preferred embodiment, using the Bluetooth protocol, Wireless Detection refers both to discovering new Wireless-Capable Devices (Bluetooth-enabled cell phones for example) that have rendered themselves detectable as per the Bluetooth protocol, and to scanning for a previously discovered Wireless-Capable Device whose identity may already be stored in memory. These are two different Wireless Detection procedures using the Bluetooth protocol, which the preferred embodiment of the Scanner can choose from based on information stored in it's non-volatile memory. These and other procedures for Wireless Detection are described in the commonly available Bluetooth standards, and are well known to a practitioner of the art.

In another preferential embodiment, the WCD is an RFID tag (possibly placed on a key chain), the Triggering Event is a signal from a sensor responsive to the opening of a door, and the Alert is an audible sound such as a tone or voice. Wireless Detection is performed by the WCD responding, either actively or passively, to a broadcast radio signal from the Scanner.

### DETAILED DESCRIPTION OF THE PREFERRED EMBODIMENTS

In a preferred embodiment, the Scanner is located in the user's vehicle and is coupled to the vehicles electrical system using the vehicle's 12 VDC accessory port. The vehicle energizes and de-energizes the 12 VDC accessory port responsive to/with the vehicle ignition system. That is, when the vehicle ignition is activated, the accessory port is energized with 12 VDC. Similarly, when the vehicle ignition is deactivated, the accessory port is de-energized. So, in this particular embodiment, the Triggering Event is the application of power to the Scanner. The Alert is both an audible tone and a bi-color LED. Further, in this preferred embodiment, the Wireless-Capable Device is a mobile phone capable of using the Bluetooth wireless communications protocol (“Bluetooth”).

In this preferred embodiment, Bluetooth was selected, and consequently requires several steps, particular to the Bluetooth wireless communications protocol, to perform

Wireless Detection. Different embodiments, possibly employing a different wireless communications protocol, would require steps appropriate to that particular protocol. It should also be understood that this is one example of an embodiment which uses the Bluetooth protocol, and that other methods of obtaining an identifying response from a WCD are possible using Bluetooth.

The various figures describe the operating modes of the preferred embodiment of the Scanner to support the Bluetooth protocol requirements for learning the identification code of the WCD, and then using those identification codes to complete Wireless Detection.

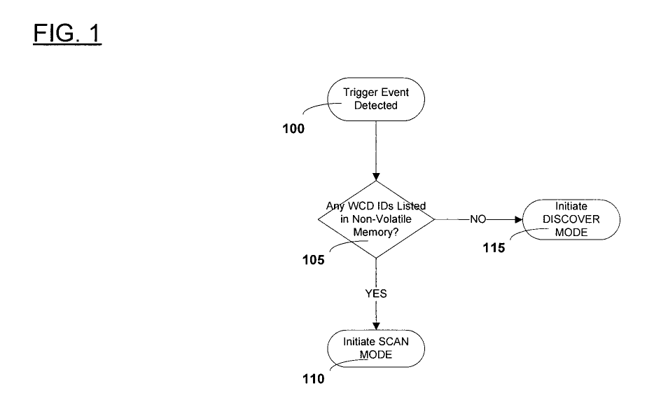

FIG. 1 shows the Scanner mode when it is powered on. In this embodiment, starting the vehicle also energizes the Scanner (100) and this is the Triggering Event. The Scanner checks whether any Bluetooth IDs are present in non-volatile memory (105). If there are Bluetooth IDs present in non-volatile memory (105), then the Scanner will initiate Scan Mode (110). Otherwise, it will enter Discover Mode (115). Both Scan Mode and Discover Mode include methods of Wireless Detection performed by the Scanner in this embodiment. In another similar embodiments, an analog or digital signal, provided by the vehicle to indicate that the vehicle has been, or is about to be, started could serve as the Triggering Event.

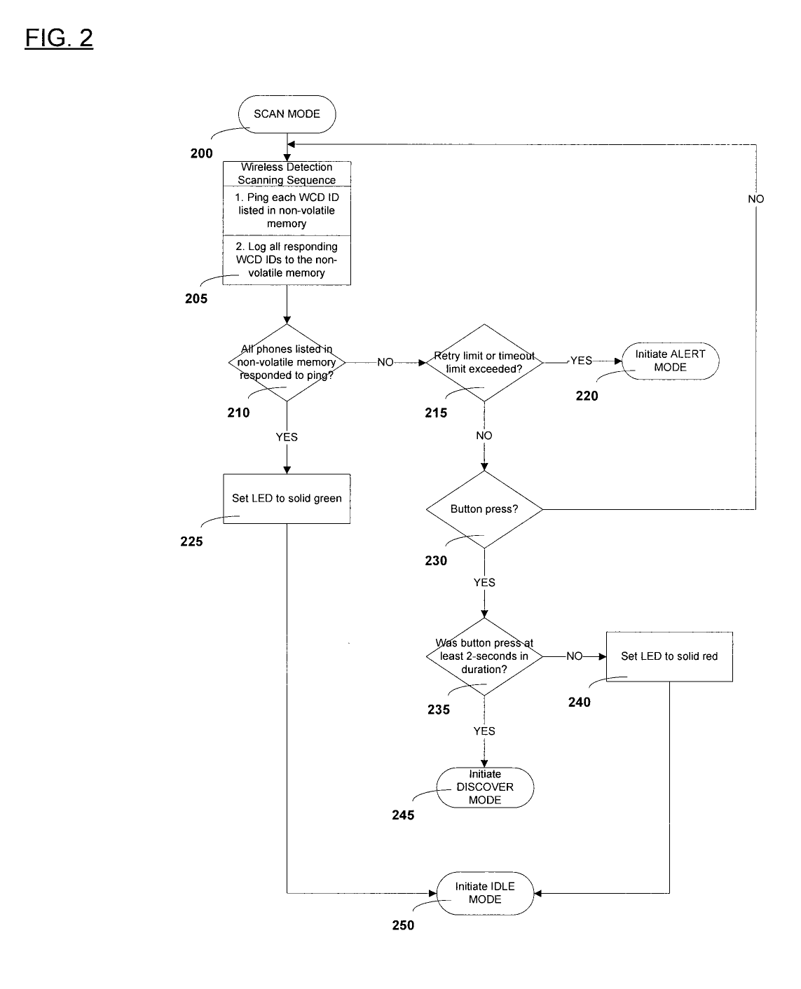

FIG. 2 details the Scan Mode of the preferred embodiment. In Scan Mode, the

Scanner will detect one or more Bluetooth capable WCDs of which it has previously obtained the Bluetooth address. This can be done by various methods. However, the preferred embodiment uses the Service Discovery Protocol (SDP), which is part of the Bluetooth protocol stack, generally known to a practitioner of the art and part of the Bluetooth protocol standard.

The SDP allows a Bluetooth capable device to query what capabilities another Bluetooth enabled device has. In this case, the Scanner is using SDP to query the WCD, but the Scanner is only looking for a response. The Scanner is not using the information reported by the query (such as what Bluetooth protocol stacks are supported by the WCD). The Scanner is merely using the SDP query to determine if the WCD responds, and thus perform Wireless Detection. If the WCD responds, then the WCD is determined to be present, and if it does not respond, then it is determined to be not present.

It is again noted that there are many other methods, using Bluetooth or other protocols, to elicit a reply from a WCD. These methods are typically documented in the protocol definition, and are well understood by a practitioner of the art. In the preferred embodiment, a Bluetooth SDP query is used because it is widely supported, and generally does not required the WCD to enter Bluetooth “discoverable” mode.

Upon initiating Scan Mode (200) the Scanner commences Wireless Detection Scanning Sequence (205) during which, for each Bluetooth address stored in the Scanner's memory, an SDP query is transmitted and the Scanner waits a short time for a wireless response (“Ping”). Responses to the SDP are logged. The scanner may optionally Ping each device multiple times, omitting any WCD that has already responded. The Scanner checks whether all devices have responded (210). If all WCDs have responded (210), then the Scanner sets it's LED to solid green (225) and initiates Idle Mode (250). If there are some WCDs that have not responded (210), the Scanner checks whether the retry limit or timeout limit has been exceeded (215). If a limit has been exceeded (215), then the Scanner initiates Alert Mode (220). If a limit has not yet been exceeded (215), then the Scanner checks for a button press (230). If a button press (230) has not occurred, the Scanner returns to Wireless Detection Scanning Sequence (205). If a button press (230) has occurred, the Scanner further checks whether the button press was at least two seconds in duration (235). If the button press (230) was not at least two seconds in duration (235) then the Scanner sets it's LED to solid red (240) and initiates Idle Mode (250). If the button press (230) was at least two seconds in duration (235) then the Scanner initiates Discover Mode (245). In another similar embodiment, the Scanner would be provided with the number of WCDs to detect and would alert if the proper number of phones was not detected at vehicle start. A natural extension of this embodiment would be for the Scanner to integrate with the vehicle in such a manner as to have information related to the number of occupants in the vehicle. In this case, the Scanner would attempt to detect the same number of WCDs as the number of occupants and alert if the number were smaller. In yet another embodiment, the Scanner could merely detect the number of WCDs and report this number on the vehicle display. In this manner, there would not be an a priori assumption of the correct number of WCDs to detect. In yet another embodiment, the Scanner would only provide an Alert if the number of WCDs detected was different from the previous number detected on the previous Trigger Event.

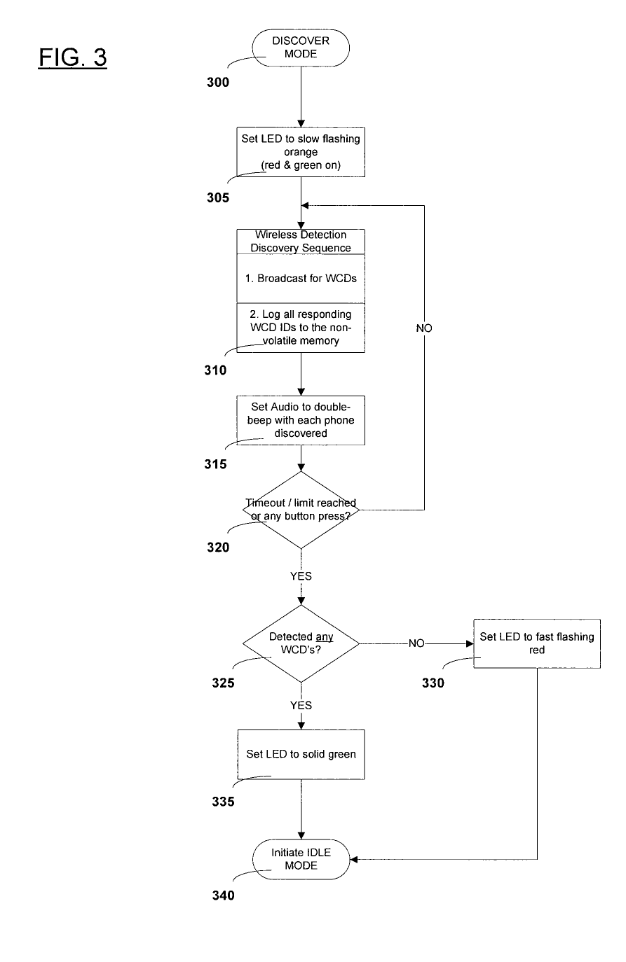

FIG. 3 details the Discover Mode of the preferred embodiment. Discover Mode is a feature of the preferred embodiment to support Wireless Detection using Bluetooth protocol. Upon initiating Discover Mode (300) the Scanner sets the LED to slow flashing orange (305). The red and orange elements are both energized to produce the orange color in a bi-color LED. The Scanner commences Wireless Detection Discovery Sequence (310) in which the Scanner will attempt to perform a Bluetooth inquiry to get the Bluetooth address of available devices. The Bluetooth addresses are included in any properly formatted wireless response to the inquiry, as defined by the Bluetooth protocol standard. WCDs with Bluetooth may need to be placed in a special mode that enables the devices to answer the initial inquiry (i.e., to be made discoverable). How this is done is dependent on the WCD, and the method of doing this is specific to each WCD, and not part of the Scanner.

However, placing a WCD (such as a cell phone), in Bluetooth discoverable mode is a common practice and is used when coupling the WCD to a Bluetooth device such as a wireless headset. An audio double-beep is produced by the Scanner for each responding device that has been detected by the Scanner (315). The Scanner checks whether the timeout or retry limit has been exceeded or whether a button press has occurred (320). If the limit has not been exceeded and a button press has not been detected (320), then the system returns to Wireless Detection Discovery Sequence (310). If the limit has been exceeded or a button press has been detected (320), then the system checks whether any WCDs have been detected (325). If no WCDs were detected (325), then the Scanner sets the LED to fast flashing red (330) and initiates Idle Mode (340). If any phones were detected (325), then the Scanner sets the LED to solid green (335) and initiates Idle Mode (340).

Again, it is noted that the preferred embodiment is using the Bluetooth protocol. Other embodiments may not need a “Discover Mode.” The preferred embodiment uses/follows the Bluetooth standard for inquiring of a Bluetooth capable device what its Bluetooth address is, and later eliciting a response from the Bluetooth capable device by using that identifying Bluetooth address. Other embodiments, possibly using other protocols, can use other means to elicit a wireless response from the WCD to perform Wireless Detection. These means are documented in the various wireless protocol standards, and/or are generally known in the art.

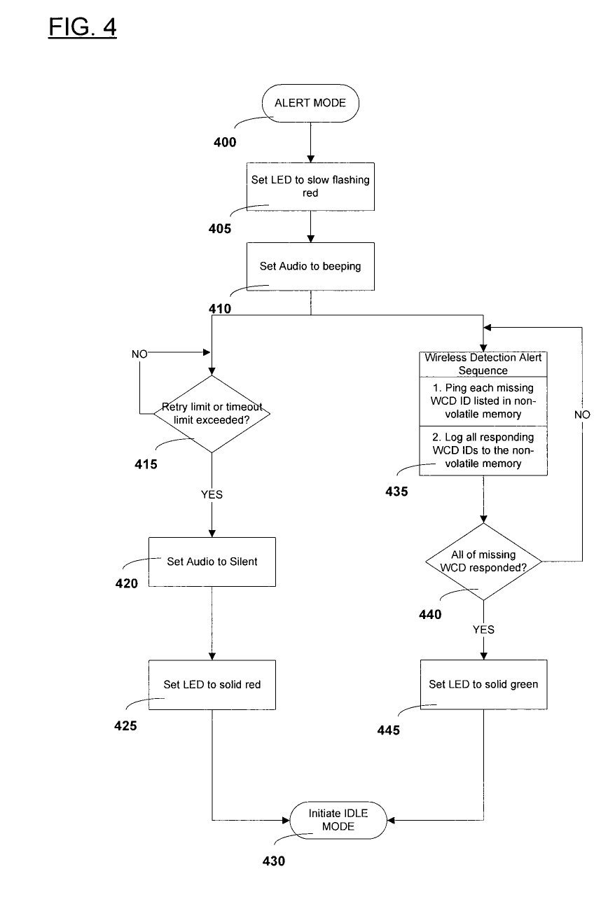

FIG. 4 details the Alert Mode of the preferred embodiment. Upon initiating Alert Mode (400) the Scanner sets the LED to slow flashing red (405) and sets the audio to continuous beeping (410). The Scanner checks whether the timeout or retry limit has been exceeded or whether a button press has occurred (415). If the limit has not been exceeded and a button press has not been detected (415), then the Scanner continues checking for these events. If the limit has been exceeded or a button press has been detected (415), then the audio is set to silent (420), the LED is set to solid red (425) and Idle Mode is initiated (430). At the same time as the Scanner checks whether the timeout or retry limit has been exceeded or whether a button press has occurred (415), the Scanner is also attempting Wireless Detection Alert Sequence (435) on the missing phones. If Wireless Detection Alert Sequence (435) detected the missing phones (440), then the Scanner sets the LED to solid green (445) and initiates Idle Mode (430). If Wireless Detection Alert Sequence(435) has not detected the missing phones (440), then it continues Wireless Detection Alert Sequence (435) until it is terminated by the exceeding the timeout or retry limit or by a button press (415).

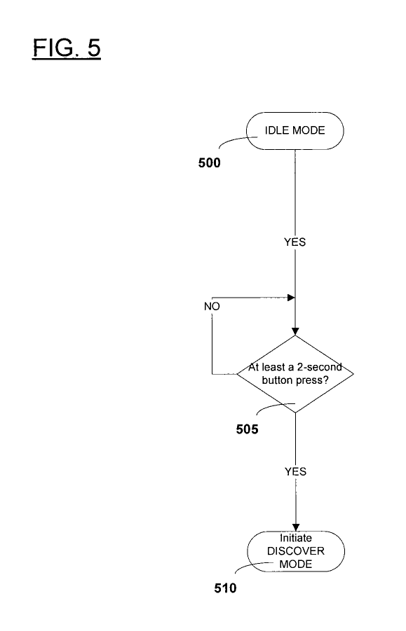

FIG. 5 details the Idle Mode of the preferred embodiment. Upon initiating Idle Mode (500) the Scanner checks for a button press of at least two seconds in duration (505). If a button press of at least two seconds in duration has occurred (505), the system initiates Discover Mode (510). Otherwise, if a button press of at least two seconds in duration has not occurred (505), then the Scanner continues to monitor for the button press (505) to occur. Idle Mode may also be implemented as a low power mode in which the Scanner is essentially asleep and consumes minimal power.

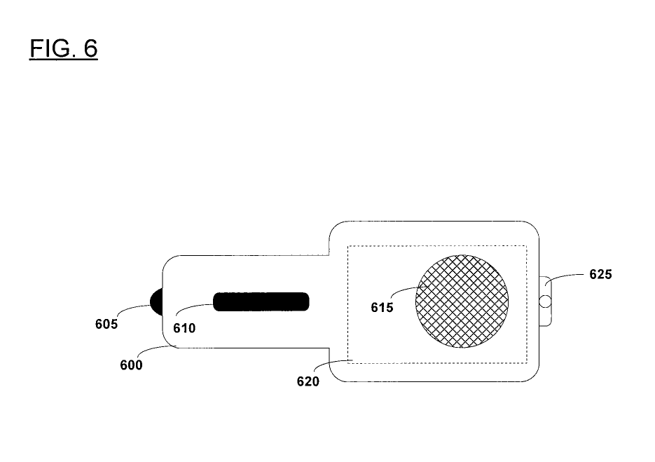

FIG. 6 shows a preferred embodiment of the Scanner for attachment to a 12 VDC automotive accessory outlet. The body (600) is made of rigid, electrically insulating material such as plastic to provide an enclosure for the internal components. The body (600) has openings to allow the penetration of electrical connections, specifically a positive terminal (605) and negative terminal (610). The positive and negative terminals, in this embodiment, are used for both powering the Scanner and using this power as the Trigger Event. In other embodiments, especially those in which the 12 VDC accessory outlet remains energized when the vehicle is turned off, could use well known signal processing techniques and widely available analog-to-digital converter (ADC) sensors to determine whether the vehicle is running or not based on the terminal voltage at the accessory outlet. In this alternative embodiment, the starting of the vehicle may show a characteristic voltage dip during cranking and a subsequent higher voltage during running. This pattern could be used as the Triggering Event.

In the preferred embodiment, with the Scanner inserted into the vehicle's 12 VDC accessory output, the sound output port (615) and lighted pushbutton (625) will protrude and be accessible to the vehicles driver and/or occupants. Circuitry (620) would be housed inside the Scanner body (600). The lighted pushbutton (625) integrates both the functionality of the pushbutton switch and the LED as previously described.

In another preferred embodiment where the Scanner is integrated into a vehicle during manufacture, the vehicle dashboard can be used to supplement or replace the button and LED described in the previous figures. Furthermore, the vehicle computer, other circuitry and/or integrated Bluetooth could be used to supplement or replace the remaining components described in the previous figures.

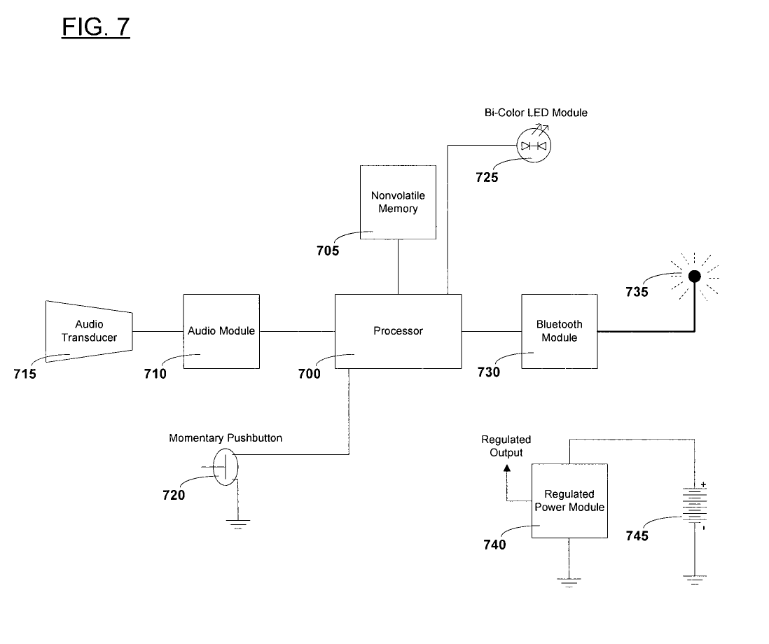

FIG. 7 diagrams the components and connections of the preferred embodiment. The Scanner is controlled by a processor (700) which is a microcontroller, but could also be a microprocessor, application specific integrated circuit (ASIC), field-programmable gate array (FPGA), or the like.

The Scanner, in the preferred embodiment, has non-volatile memory or battery-backed up random access memory (705) to store Bluetooth address of WCDs. The non-volatile memory (705) could be external or internal to the processor (700). The processor communicates to an audio module (710), which produces an audio signal on the attached speaker or suitable audio transducer (715) to provide an audible indication of system states.

The output of the audio module (710) could produce any audible indication, such as a set of beeps, or recorded voice prompts. There is also a momentary pushbutton (720) for user input to initiate the discovery of new devices, for inclusion in the set of devices stored in the non-volatile memory, to halt wireless detection, to clear an alarming condition, etc.

A bi-color LED module (725) provides visible indications of various colors and modes (such as on, off, solid, blink, fast blink, slow blink) to indicate various system states, such as successful acquisition of at least one device programmed into the Scanner for scanning, unsuccessful acquisition of one or more devices programmed into the Scanner for scanning, successful addition of a new device into the Scanner for scanning, a Scanner scan in progress, and other states as programmed.

The output of the visual module could be any visible indication, such as a set of LEDs, or an LCD screen displaying alpha-numeric information. The LEDs could be replaced by the integrated vehicle display (such as dashboard display, navigation system display, or other) used to communicate information to the user.

Finally, there is a wireless Bluetooth transceiver module (730) for communicating with the WCD's. Antenna (735) may be integrated within the Bluetooth transceiver module (730) or provided externally. It should be noted that much of the Bluetooth module (735) may be built into the processor (700) itself, as might other sub-systems such as the audio module (710). Power is supplied to all sub-systems as necessary (connections not shown) by Power Module (740), which would transform the automobile 12-14 VDC (745) to voltages appropriate to the sub-systems described here.

There are many envisioned embodiments with small variations on the preferred embodiment. In one such embodiment, the entire apparatus of FIG. 7 could be replaced with suitable systems within the vehicle itself to accomplish the various functions described here.

Other envisioned embodiments include using RFID tags as the WCD, using a wireless protocol published by the RFID tag manufacturer. The WCD may be attached to other objects, such as an inhaler, epinephrine auto-injector (EpiPen), keys, or other essential devices that the user of the Scanner would like to have at the time of the Triggering Event.

Envisioned embodiments also include situations in which the Scanner is not in a vehicle. It could be on a household door, and the Triggering Event could be the opening of the door. Envisioned embodiments include Scanners that are powered by batteries (like the preferred embodiment) or by other power sources such as household electrical service.

What is claimed is:

1. An apparatus that Alerts a user that one or more Wireless-Capable Devices are not present at the time of a Triggering Event where the presence or non-presence of the Wireless-Capable Devices is determined via Wireless Detection of the Wireless-Capable Devices by the apparatus.

2. The apparatus of claim 1 in which the Wireless Detection uses Bluetooth® for communicating with at least one Wireless Capable Device.

3. The apparatus of claim 1 in which the Wireless Capable Device is a cell phone.

4. The apparatus of claim 1 in which the Triggering Event is a signal from a sensor, processor or switch responsive to the starting of a coupled vehicle.

5. The apparatus of claim 1 in which the Triggering Event is a signal from a sensor, processor or switch responsive to the opening of a door.

6. An apparatus that Alerts a user that a specified number of Wireless-Capable Devices are not present at the time of a Triggering Event where the presence or non-presence of the Wireless-Capable Devices is determined via Wireless Detection of the Wireless-Capable Devices by the apparatus.

7. The apparatus of claim 6 in which the specified number of Wireless-Capable Devices is specified by a user.

8. The apparatus of claim 6 in which the specified number of Wireless-Capable Devices is the number of occupants in a vehicle.

9. The apparatus of claim 6 in which the specified number of Wireless-Capable Devices is the number of Wireless-Capable Devices previously detected by the apparatus when using Wireless Detection.

10. The apparatus of claim 6 in which the Wireless Detection uses the Bluetooth® for communicating with at least one Wireless Capable Device.

11. The apparatus of claim 6 in which the Wireless Capable Device is a cell phone.

12. The apparatus of claim 6 in which the Triggering Event is a signal from a sensor, processor or switch responsive to the starting of a coupled vehicle.

13. The apparatus of claim 6 in which the Triggering Event is a signal from a sensor, processor or switch responsive to the opening of a door.

14. An apparatus that Alerts a user that any Wireless-Capable Devices in a stored list of Wireless-Capable Devices are not present at the time of a Triggering Event where the presence or non-presence of the Wireless-Capable Devices is determined via Wireless Detection of the Wireless-Capable Devices by the apparatus.

15. The apparatus of claim 14 in which the Wireless Detection uses Bluetooth® for communicating with at least one Wireless Capable Device.

16. The apparatus of claim 14 in which the Wireless Capable Device is a cell phone.

17. The apparatus of claim 14 in which the Triggering Event is a signal from a sensor, processor or switch responsive to the starting of a coupled vehicle.

18. The apparatus of claim 14 in which the Triggering Event is a signal from a sensor, processor or switch responsive to the opening of a door.

19. An apparatus that Alerts a user that all Wireless-Capable Devices in a stored list of Wireless-Capable Devices are not present at the time of a Triggering Event where the presence or non-presence of the Wireless-Capable Devices is determined via Wireless Detection of the Wireless-Capable Devices by the apparatus.

20. The apparatus of claim 19 in which the Wireless Detection uses Bluetooth® for communicating at least one Wireless Capable Device.

21. The apparatus of claim 19 in which the Wireless Capable Device is a cell phone.

22. The apparatus of claim 19 in which the Triggering Event is a signal from a sensor, processor or switch responsive to the starting of a coupled vehicle.

23. The apparatus of claim 19 in which the Triggering Event is a signal from a sensor, processor or switch responsive to the opening of a door.
